(19) United States
(12) Patent Application Publication
(10) Pub. No.: US 2026/0322556 A1
(43) Pub. Date: Oct. 15, 2026

(54) INTELLIGENT DEMODULATION REFERENCE SIGNAL (DMRS) ALLOCATION

(71) Applicant: T-Mobile USA, Inc., Bellevue, WA (US)

(72) Inventors: Yu WANG, Fairfax, VA (US); Zheng FANG, McLean, VA (US)

(21) Appl. No.: 19/180,083

(22) Filed: Apr. 15, 2025

(51) Int. Cl. H04L 5/00; H04B 7/06

(52) U.S. Cl. CPC H04L 5/0051; H04B 7/0626; H04L 5/0044

(57) ABSTRACT

Disclosed solutions provide intelligent demodulation reference signal (DMRS) allocation. When a user equipment (UE) is in good signal conditions, such as stationary, with low interference, strong received power and slowly varying channel characteristics, multiple DMRS symbols are not needed for reliable demodulation. Rather, the downlink (DL) and/or uplink (UL) signal qualities are monitored, so that the count of DMRS symbols used (in each direction) may be optimized. This permits reliable demodulation in poorer signal conditions, while improving data throughput in better signal conditions, by approximately 10% (on the DL, UL is slightly lower). For examples, DMRS symbol count may be reduced from two per time slot to only one, and in some scenarios, if signal conditions are sufficiently good, some slots may be skipped and have no DMRS symbols at all. Some examples may place a single DMRS symbol per slot in position 7 (i.e., the slot center).

### BACKGROUND

Demodulation reference signal (DMRS) symbols are used to provide a reference for assisting in demodulation, in order to reduce bit error rate (BER) in at least fifth generation (5G) cellular systems. Later cellular generations may use symbols that are equivalent to 5G DMRS symbols. DMRS symbols may be used for both a downlink (DL) traffic channel, such as a physical downlink shared channel (PDSCH), and an uplink (UL) traffic channel, such as a physical uplink shared channel (PUSCH). That is, both the cell site and user equipment (UE), such as mobile cellphones and stationary fixed wireless access (FWA) devices and customer premises equipment (CPE), may both transmit and receive DMRS symbols.

Multiple DMRS symbols (e.g., two) are typically used per time slot (i.e., one fourth of a frame) within a single frequency, replacing a data symbol. Although this displaces data, cutting into potential throughput, it accommodates user equipment (UEs) that are in poor signal conditions, such as low signal power, high interference levels, and/or moving rapidly (which introduces a Doppler effect). However, when a UE is in good signal conditions, such as stationary in place, with low interference and strong DL and UL received power, the multiple DMRS symbols are not needed and are thus superfluous. This means that data throughput capacity is being unnecessarily reduced.

### SUMMARY

The following summary is provided to illustrate examples disclosed herein, but is not meant to limit all examples to any particular configuration or sequence of operations.

Solutions are disclosed that provide intelligent demodulation reference signal (DMRS) allocation. Examples determine, by a wireless network, a downlink (DL) channel condition of a DL traffic channel for a user equipment (UE) using a first UE feedback signal; based on at least the DL channel condition, select a count of demodulation reference signal (DMRS) symbols to use in DL slots of the DL traffic channel, wherein a first quality level indicates higher signal quality that a second quality level, and wherein a lower count of DMRS symbols is used when the DL channel condition is within the first quality level than when the DL channel condition is within the second quality level; identify, to the UE, a position or positions of DMRS symbols in a first DL slot; and transmit, on the DL traffic channel, data in the first DL slot with a DMRS symbol in the identified position or positions, according to the count of DMRS symbols.

Additional examples determine, by a wireless network, an uplink (UL) channel condition of a UL traffic channel for a UE using a first UE reference signal; based on at least the UL channel condition, select a count of DMRS symbols to use in UL slots of the UL traffic channel, wherein a first quality level indicates higher signal quality that a second quality level, and wherein a lower count of DMRS symbols is used when the UL channel condition is within the first quality level than when the UL channel condition is within the second quality level; identify, to the UE, a position or positions of DMRS symbols in a first UL slot; and transmit, on the UL traffic channel, data in the first UL slot with a DMRS symbol in the identified position or positions, according to the count of DMRS symbols.

Additional examples determine, by a wireless network, a DL channel condition of a DL traffic channel for a UE using a first UE feedback signal; based on at least the DL channel condition, determine whether to include a DMRS symbol in each DL slot, wherein a first quality level indicates higher signal quality that a second quality level, and wherein a DMRS symbol is not included in each DL slot when the DL channel condition is within the first quality level but a DMRS symbol is included in each DL slot when the DL channel condition is within the second quality level; and based on at least determining to not include a DMRS symbol in each DL slot: transmit, on the DL traffic channel, data in a first DL slot with a DMRS symbol; and transmit, on the DL traffic channel, data in a second DL slot without DMRS symbols.

Additional examples determine, by a wireless network, a UL channel condition of a UL traffic channel for a UE using a first UE reference signal; based on at least the UL channel condition, determine whether to include a DMRS symbol in each UL slot, wherein a first quality level indicates higher signal quality that a second quality level, and wherein a DMRS symbol is not included in each UL slot when the UL channel condition is within the first quality level but a DMRS symbol is included in each UL slot when the UL channel condition is within the second quality level; and based on at least determining to not include a DMRS symbol in each UL slot: transmit, on the UL traffic channel, data in a first UL slot with a DMRS symbol; and transmit, on the UL traffic channel, data in a second UL slot without DMRS symbols.

### BRIEF DESCRIPTION OF THE DRAWINGS

The disclosed examples are described below with reference to the accompanying drawing figures listed below, wherein:

FIG. 1 illustrates an exemplary architecture that advantageously provides intelligent demodulation reference signal (DMRS) allocation;

FIGS. 2A, 2B, and 2C illustrate various scenarios for both downlink (DL) and uplink (UL) channels that require differing counts of DMRS symbols, as may be encountered by examples of the architecture of FIG. 1;

FIGS. 3A and 3B show charts of channel conditions versus the number (count) of DMRS symbols used per DL and UL slot.

FIG. 4 illustrates further detail for a component of the architecture of FIG. 1;

FIGS. 5A, 5B, and 5C illustrate exemplary DL slots, as may be used in examples of the architecture of FIG. 1;

FIGS. 6A, 6B, and 6C illustrate exemplary UL slots, as may be used in examples of the architecture of FIG. 1;

FIGS. 7A, 7B, 8A, 8B, 8C, and 8D illustrate flowcharts of exemplary operations associated with the architecture of FIG. 1; and

FIG. 9 illustrates a block diagram of a computing device suitable for implementing various aspects of the disclosure.

Corresponding reference characters indicate corresponding parts throughout the drawings. References made throughout this disclosure relating to specific examples, are provided for illustrative purposes, and are not meant to limit all implementations or to be interpreted as excluding the existence of additional implementations that also incorporate the recited features.

### DETAILED DESCRIPTION

Disclosed solutions provide intelligent demodulation reference signal (DMRS) allocation. When a user equipment (UE) is in good signal conditions, such as stationary, with low interference, strong received power and slowly varying channel characteristics, multiple DMRS symbols are not needed for reliable demodulation. Rather, the downlink (DL) and/or uplink (UL) signal qualities are monitored, so that the count of DMRS symbols used (in each direction) may be optimized. This permits reliable demodulation in poorer signal conditions, while improving data throughput in better signal conditions, by approximately 10 (on the DL, UL is slightly lower). For examples, DMRS symbol count may be reduced from two per time slot to only one, and in some scenarios, if signal conditions are sufficiently good, some slots may be skipped and have no DMRS symbols at all. Some examples may place a single DMRS symbol per slot in position 7 (i.e., the slot center).

Aspects of the disclosure improve data-carrying capacity of wireless networks, for example improving spectral efficiency, by optimizing the count of DMRS symbols used for the channel conditions (e.g., in both DL and UL, optimized individually). These advantageous results are accomplished, at least in part, by determining a DL or UL channel condition and, based on at least the channel condition, selecting a count of DMRS symbols to use in slots of the traffic channel. Some examples determine whether to use a DMRS symbol in each slot of the traffic channel, and transmit data in some slots without any DMRS symbols.

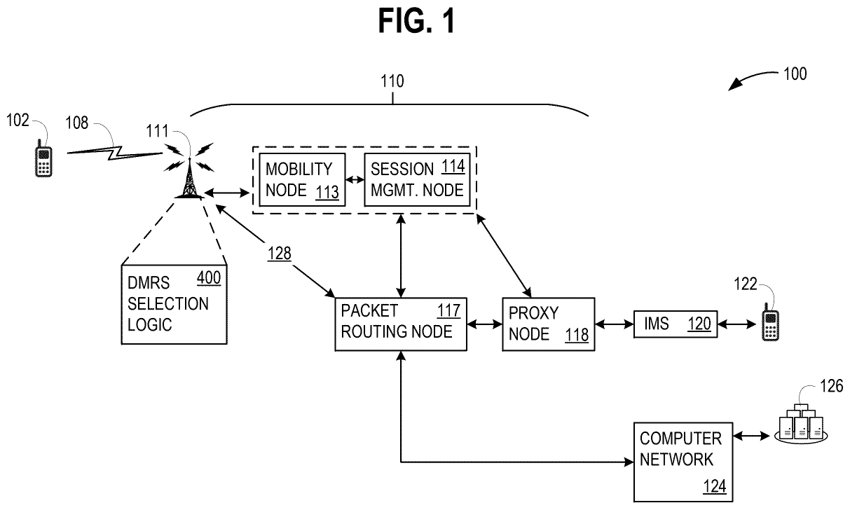

With reference now to the figures, FIG. 1 illustrates an exemplary architecture 100 that advantageously provides intelligent demodulation reference signal (DMRS) allocation. A wireless network 110 is illustrated that is serving a UE 102. UE 102 may be an enhanced mobile broadband (eMBB) or cellphone, a fixed wireless access (FWA), a consumer premises equipment (CPE) an internet of things (IoT) device, a machine-to-machine (M2M) communication device, a personal computer (PC, e.g., desktop, notebook, tablet, etc.) with a cellular modem, or another telecommunication device capable of using a wireless network. In the scene depicted in FIG. 1, UE 102 is using wireless network 110 for a packet data session to reach a network resource 126 (e.g., a website) across an external packet data computer network 124 (e.g., the internet). In some scenarios, UE 102 may use wireless network 110 for a phone call with another UE 122. Wireless network 110 may be a cellular network such as a fifth generation (5G) network, a fourth generation (4G) network, or another cellular generation network. In some contexts, 5G is also referred to as new radio (NR), and standalone 5G, which is a full 5G implementation that does not rely on 4G technology for some functionality, may be referred to SA NR.

UE 102 uses an air interface 108 to communicate with a base station 111 of wireless network 110, such that base station 111 is the serving base station for UE 102 (providing the serving cell). In some scenarios, base station 111 may be referred to as a radio access network (RAN). Wireless network 110 has a mobility node 113, a session management node 114, and other components (not shown). Wireless network 110 also has a packet routing node 117 and a proxy node 118. Mobility node 113 and session management node 114 are within a control plane of wireless network 110, and packet routing node 117 is within a data plane (a.k.a. user plane) of wireless network 110.

Base station 111 is in communication with mobility node 113 and packet routing node 117. Mobility node 113 is in communication with session management node 114, which is in communication with packet routing node 117, and proxy node 118. Packet routing node 117 is in communication with proxy node 118 and computer network 124. In some 5G examples, base station 111 comprises a gNodeB (gNB), mobility node 113 comprises an access mobility function (AMF), session management node 114 comprises a session management function (SMF), and packet routing node 117 comprises a user plane function (UPF). In some 4G examples, base station 111 comprises an eNodeB (eNB), mobility node 113 comprises a mobility management entity (MME), session management node 114 comprises a system architecture evolution gateway (SAEGW) control plane (SAEGW-C), and packet routing node 117 comprises an SAEGW-user plane (SAEGW-U). In some examples, proxy node 118 comprises a proxy call session control function (P-CSCF) in both 4G and 5G.

Proxy node 118 is in communication with an internet protocol (IP) multimedia system (IMS) 120, which uses an access gateway (IMS-AGW) in order to provide connectivity to other wireless (cellular) networks, such as for a call with a UE 122 or a public switched telephone system (PSTN, also known as plain old telephone system, POTS). In some examples, proxy node 118 may be considered to be within IMS 120. UE 102 reaches network resource 126 using computer network 124 (or IMS 120, in some examples). Data packets of data traffic 128 to/from UE 102 pass through at least base station 111 and packet routing node 117 on their way from/to computer network 124 or IMS 120 (via proxy node 118).

In some examples, wireless network 110 has multiple ones of each of the components illustrated, in addition to other components and other connectivity among the illustrated components. In some examples, wireless network 110 has components of multiple cellular technologies operating in parallel in order to provide service to UEs of different cellular generations. For example, wireless network 110 may use both a gNB and an eNB co-located at a common cell site. In some examples, multiple cells may be co-located at a common cell site, and may be a mix of 5G and 4G.

As illustrated in further detail in the remaining figures, a DMRS selection logic 400 determines (e.g., estimates) channel conditions for DL and/or UL directions, and determines how many DMRS symbols to use in each slot. Although DMRS selection logic 400 is illustrated as being located within base station 111, in some examples, DMRS selection logic 400 may be located elsewhere within wireless network 110, and/or distributed among multiple locations.

Although FIG. 1 and some of the following figures are described using an example of a cellular network, it should be understood that the teachings herein are applicable to other types of wireless networks. To benefit from the teachings herein, another wireless network, other than a cellular network, should use a DMRS symbol, where DMRS is interpreted to be a generic term, rather than specifically a 5G DMRS symbol. With such features, another type of wireless network, other than a cellular network, may also benefit from the disclosure herein.

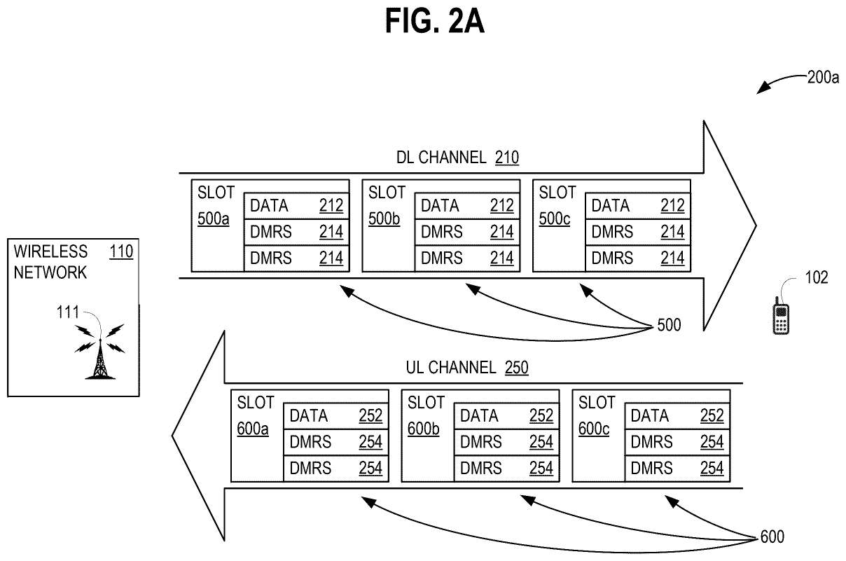

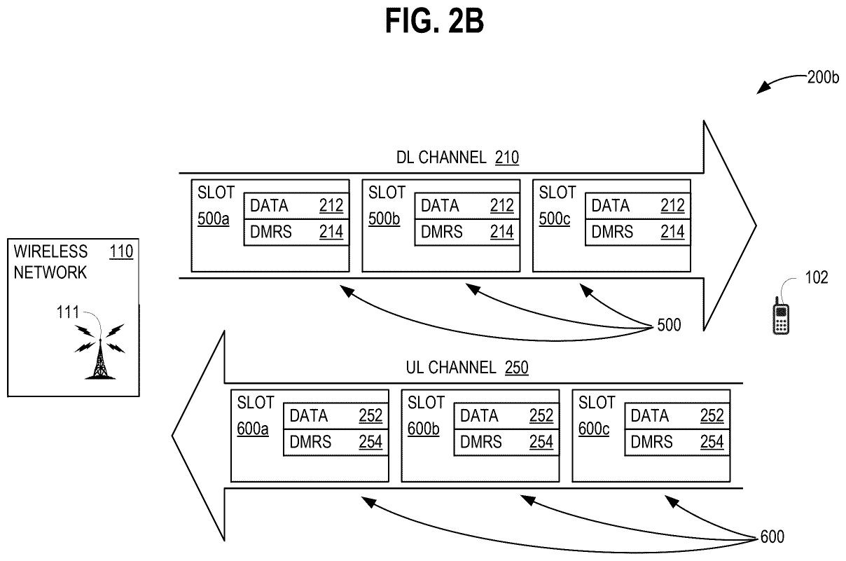

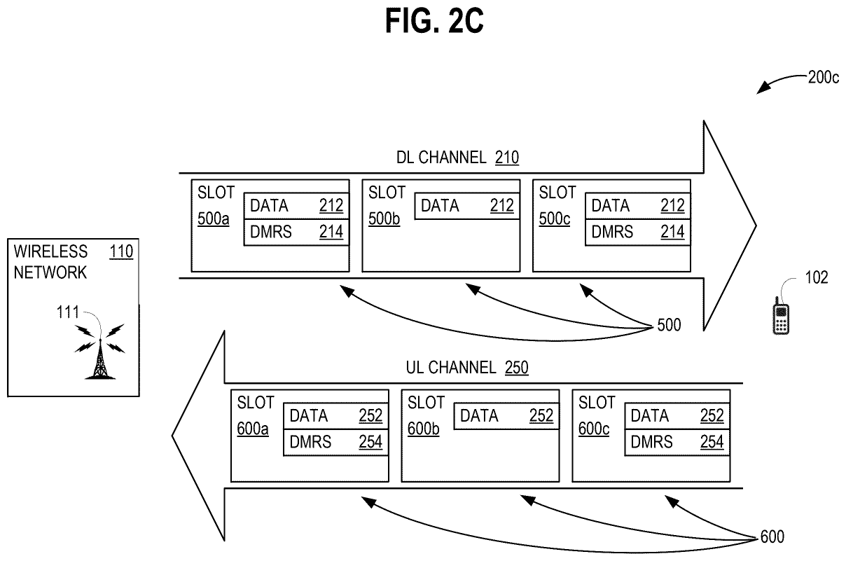

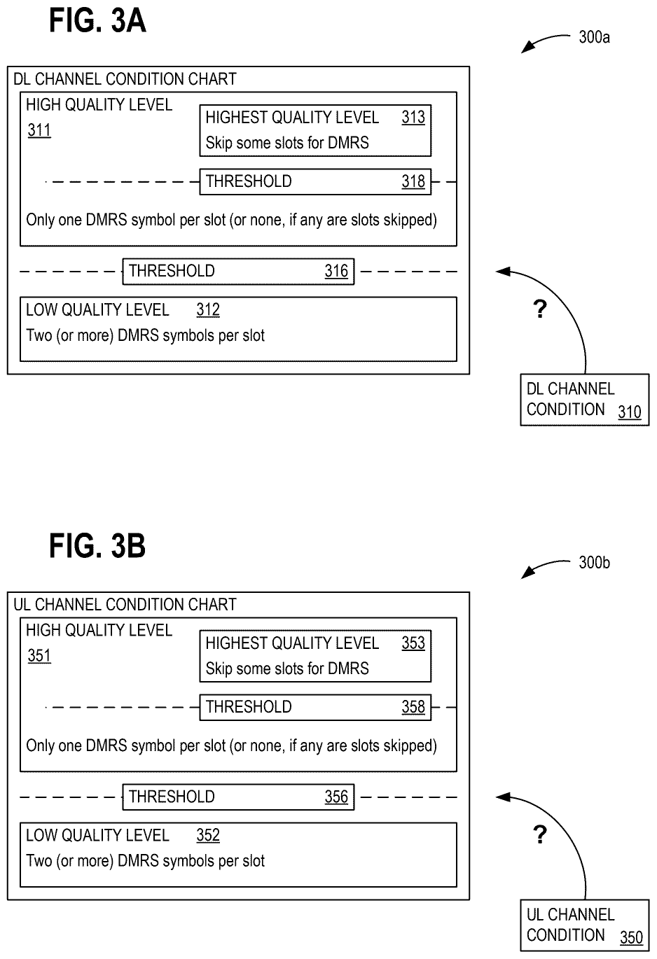

FIGS. 2A, 2B, and 2C illustrate various scenarios for both DL and UL channels that require differing counts of DMRS symbols. FIG. 2A illustrates a scenario 200a with poor signal quality, in which two DMRS symbols 214 are required per slot for DL and two DMRS symbols 254 are required per slot for UL. DL and UL DMRS symbols may be the same or may be different. Scenario 200a is associated with quality level 312 for DL and quality level 352 for UL, although the signal quality levels for DL and UL may differ in real-world conditions. Quality levels 312 and 352 are explained in relation to FIGS. 3A and 3B, respectively. Some examples may use more than two DMRS symbols per slot.

Base station 111 transmits data 212 (DL data) to UE 102 over a DL traffic channel 210, which may be a physical downlink shared channel (PDSCH). Three DL slots 500 are shown, although in 5G a frame has four slots. A first DL slot 500a has two DMRS symbols 214 in addition to data 212. A second DL slot 500b also has two DMRS symbols 214 in addition to data 212, and a third DL slot 500c also has two DMRS symbols 214 in addition to data 212.

UE 102 transmits data 252 (UL data) to base station 111 over a UL traffic channel 250, which may be a physical uplink shared channel (PUSCH). Three UL slots 600 are shown, although in 5G a frame has four slots. A first UL slot 600a has two DMRS symbols 254 in addition to data 252. A second UL slot 600b also has two DMRS symbols 254 in addition to data 252, and a third UL slot 600c also has two DMRS symbols 254 in addition to data 252.

FIG. 2B illustrates a scenario 200b with higher signal quality than scenario 200a, in which only a single DMRS symbol 214 is required per slot for DL and a single DMRS symbol 254 is required per slot for UL. Scenario 200b is associated with quality level 311 for DL and quality level 351 for UL. Quality levels 311 and 351 are also explained in relation to FIGS. 3A and 3B, respectively.

For DL traffic channel 210, three DL slots 500 shown. DL slot 500a has one DMRS symbol 214 in addition to data 212. DL slot 500b also one DMRS symbol 214 in addition to data 212, and DL slot 500c also has one DMRS symbol 214 in addition to data 212. For UL traffic channel 250, three UL slots 600 are shown. UL slot 600a has one DMRS symbol 254 in addition to data 252. UL slot 600b also has one DMRS symbol 254 in addition to data 252, and UL slot 600c also has one DMRS symbol 254 in addition to data 252. This means that both DL slots 500 and UL slots 600 are able to carry more data in scenario 200b than in scenario 200a, because some data 212 can take the place of DMRS symbol 214 and some data 252 can take the place of DMRS symbol 214.

FIG. 2C illustrates a scenario 200c with an even higher signal quality than scenario 200b, in which a DMRS symbol 214 is not required in every slot for DL or for UL. Scenario 200c is associated with quality level 313 for DL and quality level 353 for UL. Quality levels 313 and 353 are also explained in relation to FIGS. 3A and 3B, respectively.

For DL traffic channel 210, three DL slots 500 shown. DL slot 500a has one DMRS symbol 214 in addition to data 212. DL slot 500b is skipped and does not have a DMRS symbol 214, making room for more data 212. DL slot 500c returns to having one DMRS symbol 214 in addition to data 212. In this case, only one DL slot 500b is skipped, although some examples may skip more than one slot. Some examples may align skipping with frames, such that the first slot of a frame always has a DMRS symbol 214 (meaning that one or three immediately subsequent slots are skipped, but not two). For UL traffic channel 250, three UL slots 600 are shown. UL slot 600a has one DMRS symbol 254 in addition to data 252. UL slot 600b is skipped and does not have a DMRS symbol 254, making room for more data 252. UL slot 600c returns to having one DMRS symbol 254 in addition to data 252. The skipping of more than a single slot may be handled the same for UL as described for DL. Both DL slots 500 and UL slots 600 are able to carry more data in scenario 200c than in scenario 200b.

FIG. 3A shows a chart 300a for determining a DL channel condition 310. Chart 300a has a signal quality threshold 316 that separates a higher quality level 311 from a lower quality level 312. In some examples, when DL channel 210 has DL channel condition 310 at quality level 311, only one DMRS symbol 214 is used per DL slots 500a, 500b, and 500c (as shown in scenario 200b of FIG. 2B), and when DL channel 210 has DL channel condition 310 at quality level 312, two DMRS symbols 214 are used per DL slot 500a, 500b, and 500c (as shown in scenario 200a of FIG. 2A).

In some examples, quality level 311 is further divided using a signal quality threshold 318 to identify a highest quality level 313 that may be considered to be a subset of quality level 311. In some examples, when DL channel 210 has DL channel condition 310 at quality level 313, some slots are skipped, as shown in scenario 200c of FIG. 2C. That is, there is only one DMRS symbol 214 every N>1 slots, with N−1 slots being skipped.

Thus, DL channel condition 310 is within quality level 311 when DL channel condition 310 exceeds signal quality threshold 316 for plurality of UE feedback signals 410 that includes UE feedback signal 410a. DL channel condition 310 is within quality level 313 when DL channel condition 310 exceeds second signal quality threshold 318. Quality level 313 indicates a higher signal quality than quality level 311, which in turn indicates a higher signal quality than quality level 312.

Similarly, FIG. 3B shows a chart 300b for determining a UL channel condition 350. Chart 300b has a signal quality threshold 356 that separates a higher quality level 351 from a lower quality level 352. In some examples, when UL channel 250 has UL channel condition 350 at quality level 351, only one DMRS symbol 254 is used per UL slots 600a, 600b, and 600c (as shown in scenario 200b of FIG. 2B), and when UL channel 250 has UL channel condition 350 at quality level 352, two DMRS symbols 254 are used per UL slot 600a, 600b, and 600c (as shown in scenario 200a of FIG. 2A).

In some examples, quality level 351 is further divided using a signal quality threshold 358 to identify a highest quality level 353 that may be considered to be a subset of quality level 351. In some examples, when UL channel 250 has UL channel condition 350 at quality level 353, some slots are skipped, as shown in scenario 200c of FIG. 2C. That is, there is only one DMRS symbol 254 every N>1 slots, with N−1 slots being skipped.

Thus, UL channel condition 350 is within quality level 351 when UL channel condition 350 exceeds signal quality threshold 356 for plurality of UE reference signals 450 that includes UE reference signal 450a. UL channel condition 350 is within quality level 353 when UL channel condition 350 exceeds second signal quality threshold 358. Quality level 353 indicates a higher signal quality than quality level 351, which in turn indicates a higher signal quality than quality level 352.

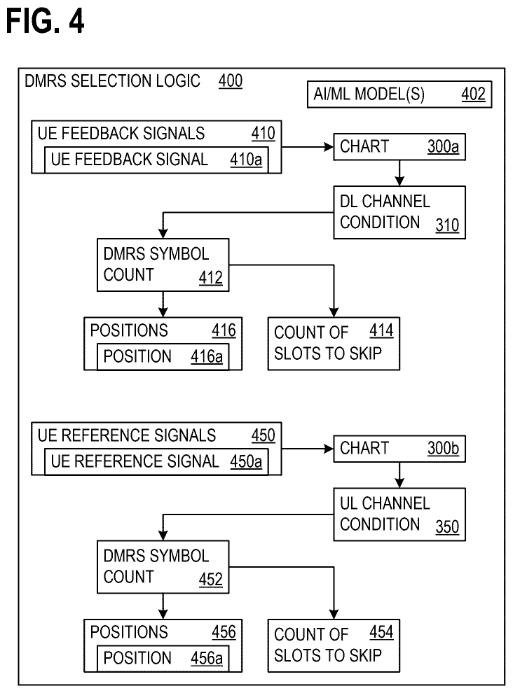

FIG. 4 illustrates further detail for DMRS selection logic 400. DMRS selection logic 400 determines DL channel condition 310 and UL channel condition 350, and selects a count 412 of DMRS symbols 214 to use for DL traffic channel 210 and a count 452 of DMRS symbols 254 to use for UL traffic channel 250. It is considered equivalent functionality, for purposes of this disclosure, to either (a) make an explicit channel condition determination and then select a count of DMRS symbols to use, or (b) select the count of DMRS symbols to use directly from channel quality information without explicitly identifying the channel condition.

For example, DMRS selection logic 400 is shown as having an artificial intelligence (AI) model 402 and collecting UE feedback signals 410 to determine DL channel condition 310 and then count 412 of DMRS symbols 214. AI model 402 may represent a single AI model or a collection of multiple AI models, each with a different training. As used herein machine learning (ML) is interchangeable with AI. Different AI models may be used for UL versus DL tasks, and for determining channel conditions versus selecting how many slots to skip, for example. AI model 402 may use UE feedback signals 410 to determine DL channel condition 310, and then selection of count 412 of DMRS symbols 214 is straightforward. Or, equivalently, AI model 402 may use UE feedback signals 410 to determine count 412 of DMRS symbols 214 directly, and DL channel condition 310 is never explicitly identified.

Plurality of UE feedback signals 410 has a UE feedback signal 410a, and others that are similar, are collected over time and may be averaged or otherwise combined. UE feedback signal 410a may be channel state information (CSI) or a measurement report (MR), or similar information. CSI may be any of a hybrid automatic repeat request (HARQ) acknowledgment (ACK) signal, a HARQ negative acknowledgment (NACK) signal, a channel quality indicator (CQI), a precoding matrix indicator (PMI), or something similar. A MR may be reference signal received power (RSRP), reference signal received quality (RSRQ), a signal-to-interference-plus-noise ratio (SINR), or something similar.

DL channel condition 310 is determined in accordance with chart 300a of FIG. 3A, which then indicates count 412 of DMRS symbols 214. This enables determining positions 416 of DMRS symbols 214 in each of DL slots 500, or determining a position 416a for a single DMRS symbol 214. In some examples, a count 414 of DL slots 500 to skip for DMRS symbols 214 is also determined. AI model 402 may determine count 414 either separately from, or together with determining count 412 of DMRS symbols 214 or DL channel condition 310.

Determination of UL channel condition 350, a count 452 of DMRS symbols 254 to use for UL traffic channel 250, positions 456 of DMRS symbols 254, and a count 454 of DL slots 600 to skip are determined similarly as described for their DL equivalents. Plurality of UE reference signals 450 has a UE reference signal 450a, and others that are similar, are collected over time and may be averaged or otherwise combined. UE reference signal 450a may be DMRS symbol on UL traffic channel 250 or a sounding reference signal (SRS), or something similar.

UL channel condition 350 is determined in accordance with chart 300b of FIG. 3B, which then indicates count 452 of DMRS symbols 254. This enables determining positions 456 of DMRS symbols 254 in each of UL slots 500, or determining a position 456a for a single DMRS symbol 254. In some examples, a count 454 of UL slots 600 to skip for DMRS symbols 254 is also determined. AI model 402 may determine count 454 either separately from, or together with determining count 452 of DMRS symbols 254 or UL channel condition 350.

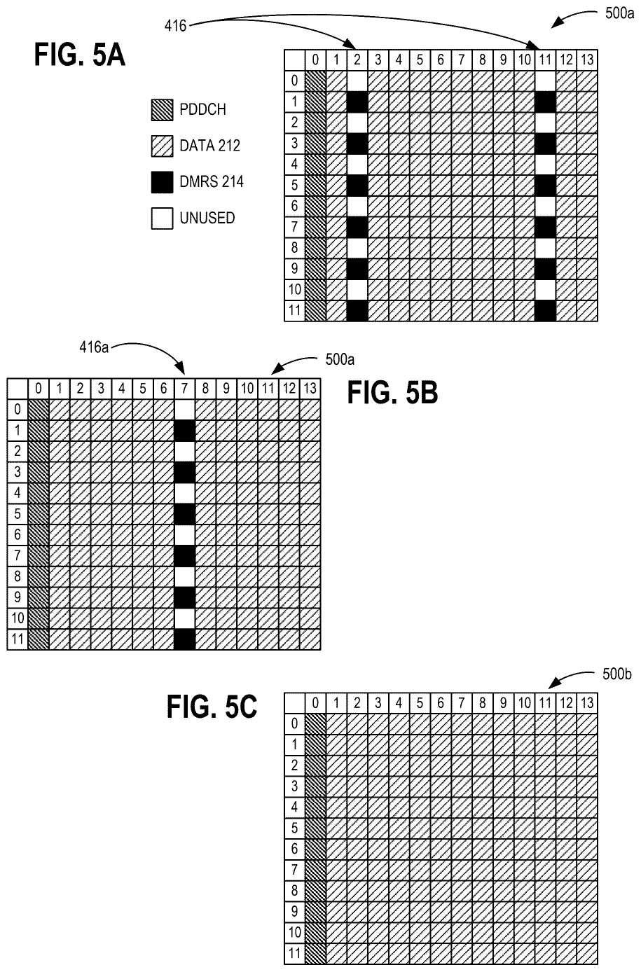

FIG. 5A shows DL slot 500a with two DMRS symbols 214, as per scenario 200a of FIG. 2A. References herein to one or two DMRS symbols per slot (for both DL and UL) mean one or two DMRS symbols per frequency in a slot, for those frequencies that have a DMRS symbol. As shown in FIG. 5A the grid of 12 by 14 resource elements (REs) has 12 rows of different frequencies and 14 columns in time, with the position numbers using 0-based indexing, such that the 12^{th} row is position number 11, and the 14^{th} column is position number 13.

There are four usage classes for the REs of DL slot 500a: physical downlink control channel (PDCCH), data 212, DMRS symbol 214, and unused (empty) REs. In some examples that use power boost, the energy that would have otherwise been used for unused (empty) REs is available for instead increasing the amount of power in the REs used for DMRS symbol 214. PDCCH REs occupy position number 0 in time for every frequency. The two DMRS symbol 214 positions 416 are position number 2 (first half of DL slot 500a) and position number 11 (second half of slot DL 500a). However, only every other frequency has a DMRS symbol 214, which are the frequencies at odd-valued position numbers 1, 3, 5, 7, 9, and 11. In FIG. 5A, there are 132 REs with data 212: 11 columns in time, and 12 frequencies.

FIG. 5B shows DL slot 500a with one DMRS symbol 214, as per scenario 200b of FIG. 2B. The grid of 12 by 14 REs has 12 rows of different frequencies and 14 columns in time. PDCCH REs occupy position number 0 in time for every frequency. The single DMRS symbol 214 position 416a is position number 7, which is in the middle of DL slot 500a, although position number 2 or position number 11 could instead be used. Only every other frequency has a DMRS symbol 214. In FIG. 5B, there are 144 REs with data 212: 12 columns in time, and 12 frequencies. This is an increase of 9% compared with scenario 200a.

FIG. 5C shows DL slot 500b without any DMRS symbol 214, as per scenario 200c of FIG. 2C. The grid of 12 by 14 REs has 12 rows of different frequencies and 14 columns in time. PDCCH REs occupy position number 0 in time for every frequency. In FIG. 5B, there are 156 REs with data 212: 12 columns in time, and 13 frequencies. This is an increase of 18% compared with DL slot 500a of scenario 200a (two DMRS symbols 214) and an increase of 8% compared with DL slot 500a of scenario 200b—although only a subset of DL slots 500 may be skipped as is shown for DL slot 500b.

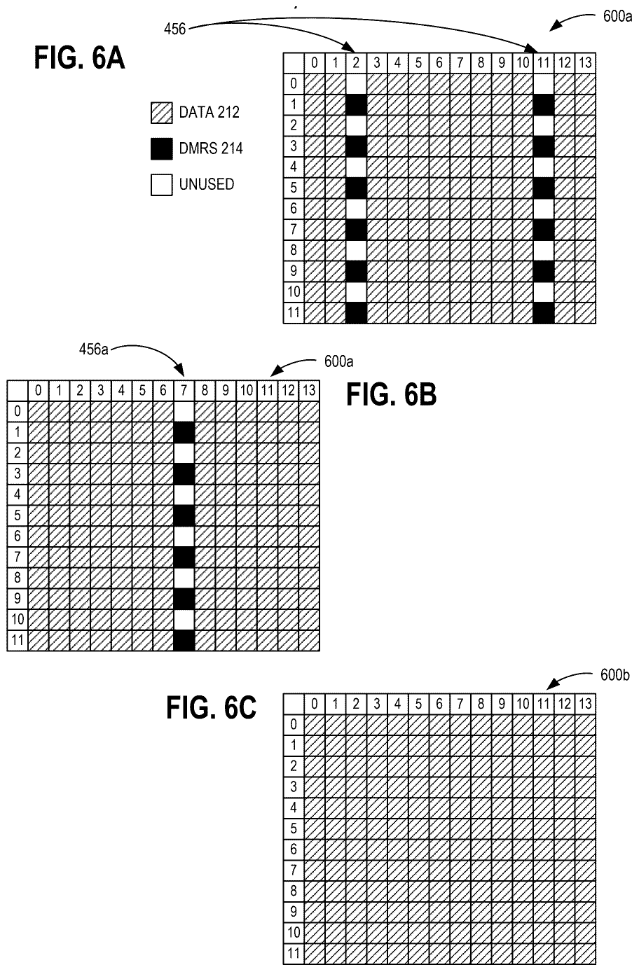

FIG. 6A shows UL slot 600a with two DMRS symbols UL4, as per scenario 200a of FIG. 2A. As shown in FIG. 6A the grid of 12 by 14 REs has 12 rows of different frequencies and 14 columns in time. There are three usage classes for the REs of UL slot 600a: data 252, DMRS UL4, and unused (empty) REs (no PDCCH). In some examples that use power boost, the energy that would have otherwise been used for unused (empty) REs is available for instead increasing the amount of power in the REs used for DMRS symbol 254. The two DMRS symbol 254 positions 456 are position number 2 (first half of UL slot 600a) and position number 11 (second half of UL slot 600a). However, only every other frequency has a DMRS symbol 254, which are the frequencies at odd-valued position numbers 1, 3, 5, 7, 9, and 11. In FIG. 6A, there are 144 REs with data 252: 11 columns in time, and 12 frequencies.

FIG. 6B shows UL slot 600a with one DMRS symbol 254, as per scenario 200b of FIG. 2B. The grid of 12 by 14 REs has 12 rows of different frequencies and 14 columns in time. The single DMRS symbol 254 position 456a is position number 7, which is in the middle of UL slot 600a, although position number 2 or position number 11 could instead be used. Only every other frequency has a DMRS symbol 254. In FIG. 6B, there are 156 REs with data 252: 12 columns in time, and 13 frequencies. This is an increase of 8% compared with scenario 200a.

FIG. 6C shows UL slot 600b without any DMRS symbol 254, as per scenario 200c of FIG. 2C. The grid of 12 by 14 REs has 12 rows of different frequencies and 14 columns in time. In FIG. 6B, there are 168 REs with data 252: 12 columns in time, and 14 frequencies. This is an increase of 17% compared with UL slot 600a of scenario 200a (two DMRS symbols 254) and an increase of 8% compared with UL slot 600a of scenario 200b—although only a subset of UL slots 600 may be skipped as is shown for UL slot 600b.

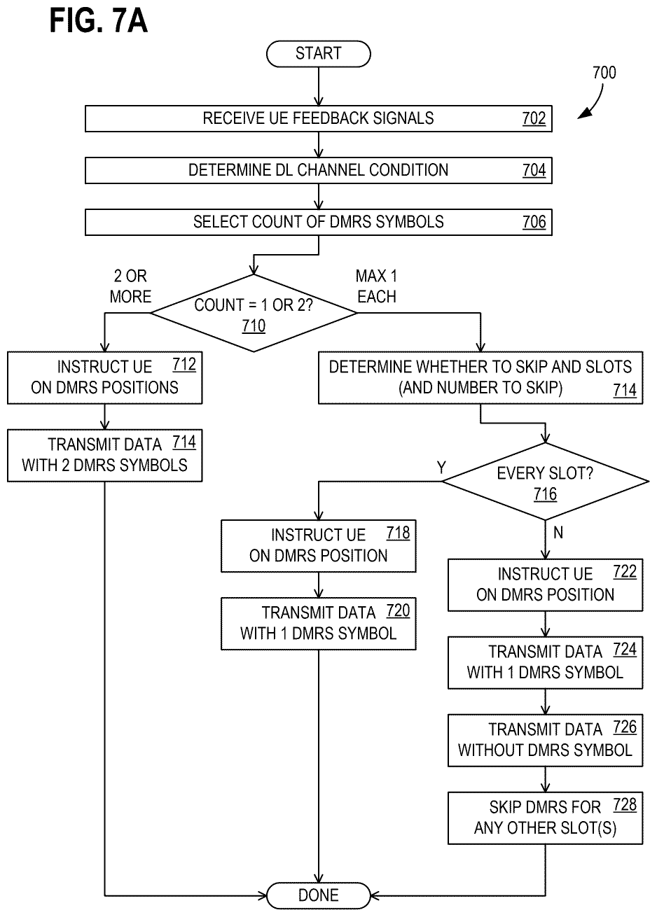

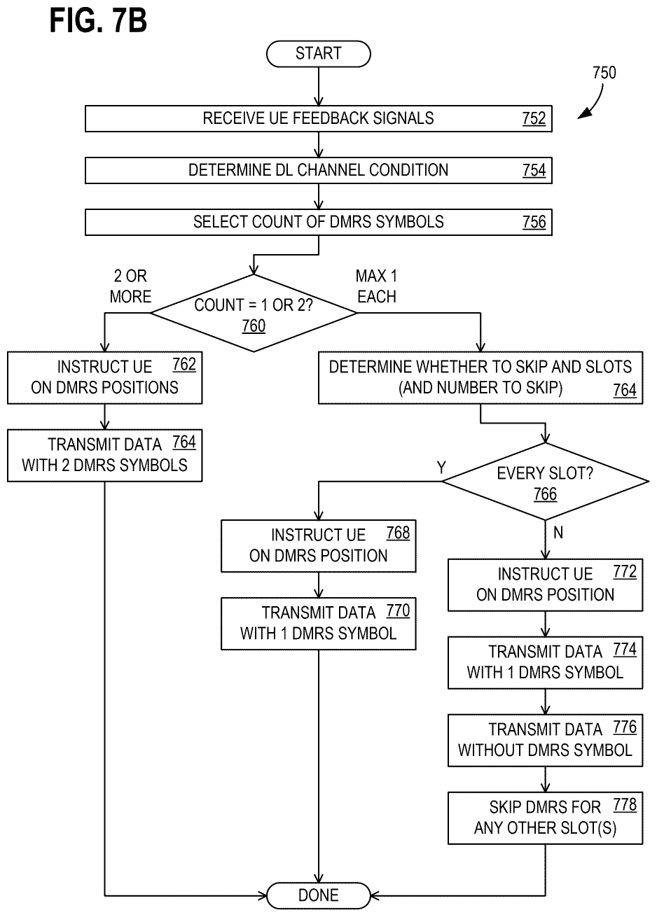

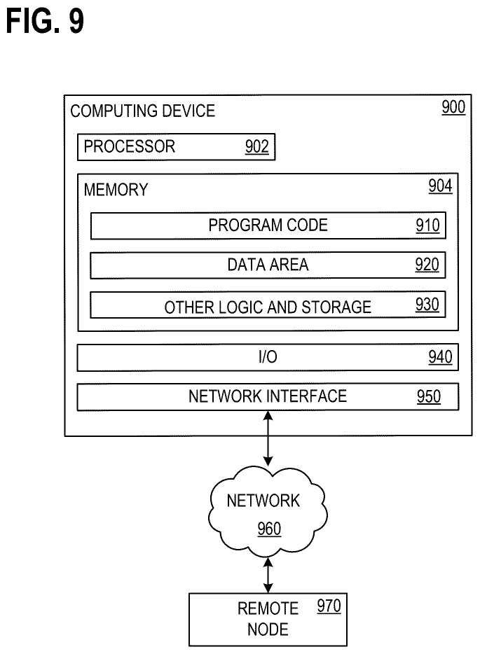

FIG. 7A illustrates a flowchart 700 of exemplary operations associated with examples of architecture 100. In some examples, at least a portion of flowchart 700 may be performed using one or more computing devices 900 of FIG. 9. Flowchart 700 commences with base station 111 of wireless network 110, and thus DMRS selection logic 400, receiving plurality of UE feedback signals 410 in operation 702. In operation 704, wireless network 110 (e.g., DMRS selection logic 400) determines (estimates) DL channel condition 310 of DL traffic channel 210 for UE 102 using at least UE feedback signal 410a, or in some examples, plurality of UE feedback signals 410.

Operation 706 selects count 412 of DMRS symbols 214 to use in DL slots 500 of DL traffic channel 210, based on at least DL channel condition 310. A lower count of DMRS symbols 214 is used when DL channel condition 310 is within quality level 311 than when DL channel condition 310 is within quality level 312. For example, count 412 is one for quality level 311, but is two for quality level 312. Determining count 412 directly from plurality of UE feedback signals 410 in a single step is equivalent to the separate operations 706 and 708 enumerated in flowchart 700, in which determining count 412 directly is a proxy for determining the quality level of DL channel condition 310.

Decision operation 708 (which may be combined with decision operation 716) determines whether two or more DMRS symbols 214 are to be used, or only a single DMRS symbol 214. If two (or more) DMRS symbols 214 are to be used, base station 111 identifies positions 416 of DMRS symbols 214 in DL slot 500a to UE 102, in operation 710. Base station 111 transmits data 212 in DL slot 500a with DMRS symbols 214, in identified positions 416, according to count 412 of DMRS symbols 214, to UE 102 on DL traffic channel 210 in operation 712. Based on at least determining that DL channel condition 310 is within quality level 312, some examples also use a power boost for DMRS symbols 214 and/or avoid multiplexing DL traffic channel 210.

If only a single DMRS symbol 214 is to be used, operation 714 determines whether to include DMRS symbol 214 in each DL slot, or skip some DL slots, based on at least DL channel condition 310. In some examples, operation 714 is combined with operation 704 and/or operation 706, and determining whether to include DMRS symbol 214 in each DL slot is also a proxy for determining DL channel condition 310. In some examples, a DMRS symbol 214 is not included in each DL slot when DL channel condition 310 is within quality level 313, although a DMRS symbol 214 is included in each DL slot when DL channel condition 310 is within quality level 312 and within quality level 311 without being in quality level 313 (i.e., when quality level 313 is a subset of quality level 311).

Decision operation 716 (which may be combined with decision operation 708) determines that a DMRS symbol 214 is included in each DL slot, base station 111 identifies position 416a of DMRS symbol 214 in DL slot 500a to UE 102, in operation 718. Base station 111 transmits data 212 in DL slot 500a with DMRS symbol 214, in identified position 416a, according to count 412 of DMRS symbols 214, to UE 102 on DL traffic channel 210 in operation 720. Based on at least determining that DL channel condition 310 is within quality level 311, some examples do not use a power boost for DMRS symbols 214 and/or may multiplex DL traffic channel 210.

If one or more DL slots 500 are to be skipped (i.e., a DMRS symbol 214 is not included in each DL slot), base station 111 identifies position 416a of DMRS symbol 214 in DL slot 500a to UE 102, in operation 722. Base station 111 transmits data 212 in DL slot 500a with DMRS symbol 214, in identified position 416a, according to count 412 of DMRS symbols 214, to UE 102 on DL traffic channel 210 in operation 724. Base station 111 then transmits data 212 in DL slot 500b, without a DMRS symbol 214, to UE 102 on DL traffic channel 210 in operation 726. Base station 111 then transmits data 212 in any additional skipped DL slots 500, without a DMRS symbol 214, to UE 102 on DL traffic channel 210 in operation 728 (i.e., skips N−2 more slots).

FIG. 7B illustrates a flowchart 750 of exemplary operations associated with examples of architecture 100. In some examples, at least a portion of flowchart 750 may be performed using one or more computing devices 900 of FIG. 9. Flowchart 750 is the equivalent of flowchart 700 of FIG. 7A, but whereas flowchart 700 is for DL, flowchart 750 is for UL. All clarifications, such as regarding optional operations and equivalent operations described for flowchart 700 also apply to flowchart 750, where operations correspond.

Flowchart 750 commences with base station 111 of wireless network 110, and thus DMRS selection logic 400, receiving plurality of UE reference signals 450 in operation 752. In operation 754, wireless network 110 (e.g., DMRS selection logic 400) determines (estimates) UL channel condition 350 of UL traffic channel 250 for UE 102 using at least UE reference signal 450a, or in some examples, plurality of UE reference signals 450.

Operation 756 selects count 452 of DMRS symbols 254 to use in UL slots 600 of UL traffic channel 250, based on at least UL channel condition 350. A lower count of DMRS symbols 254 is used when UL channel condition 350 is within quality level 351 than when UL channel condition 350 is within quality level 352. Decision operation 758 determines whether two or more DMRS symbols 254 are to be used, or only a single DMRS symbol 254. If two (or more) DMRS symbols 254 are to be used, base station 111 identifies positions 456 of DMRS symbols 254 in UL slot 600a to UE 102, in operation 760. Base station 111 transmits data 252 in UL slot 600a with DMRS symbols 254, in identified positions 456, according to count 452 of DMRS symbols 254, to UE 102 on UL traffic channel 250 in operation 762. Based on at least determining that UL channel condition 350 is within quality level 352, some examples also use a power boost for DMRS symbols 254 and/or avoid multiplexing UL traffic channel 250.

If only a single DMRS symbol 254 is to be used, operation 764 determines whether to include DMRS symbol 254 in each UL slot, or skip some UL slots, based on at least UL channel condition 350. In some examples, operation 764 is combined with operation 754 and/or operation 756, and determining whether to include DMRS symbol 254 in each UL slot is also a proxy for determining UL channel condition 350. In some examples, a DMRS symbol 254 is not included in each UL slot when UL channel condition 350 is within quality level 353, although a DMRS symbol 254 is included in each UL slot when UL channel condition 350 is within quality level 352 and within quality level 351 without being in quality level 353 (i.e., when quality level 353 is a subset of quality level 351).

Decision operation 766 (which may be combined with decision operation 758) determines that a DMRS symbol 254 is included in each UL slot, base station 111 identifies position 456a of DMRS symbol 254 in UL slot 600a to UE 102, in operation 768. Base station 111 transmits data 252 in UL slot 600a with DMRS symbol 254, in identified position 456a, according to count 452 of DMRS symbols 254, to UE 102 on UL traffic channel 250 in operation 770. Based on at least determining that UL channel condition 350 is within quality level 351, some examples do not use a power boost for DMRS symbols 254 and/or may multiplex UL traffic channel 250.

If one or more UL slots 600 are to be skipped (i.e., a DMRS symbol 254 is not included in each UL slot), base station 111 identifies position 456a of DMRS symbol 254 in UL slot 600a to UE 102, in operation 772. Base station 111 transmits data 252 in UL slot 600a with DMRS symbol 254, in identified position 456a, according to count 452 of DMRS symbols 254, to UE 102 on UL traffic channel 250 in operation 774. Base station 111 then transmits data 252 in UL slot 600b, without a DMRS symbol 254, to UE 102 on UL traffic channel 250 in operation 776. Base station 111 then transmits data 252 in any additional skipped UL slots 600, without a DMRS symbol 254, to UE 102 on UL traffic channel 250 in operation 778 (i.e., skips N−2 more slots).

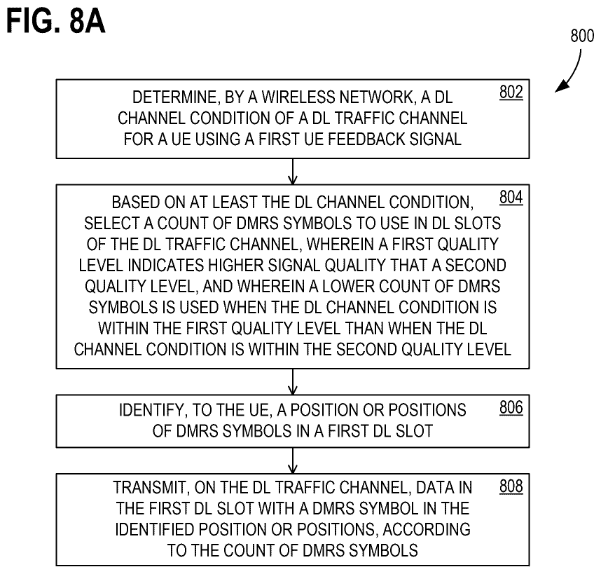

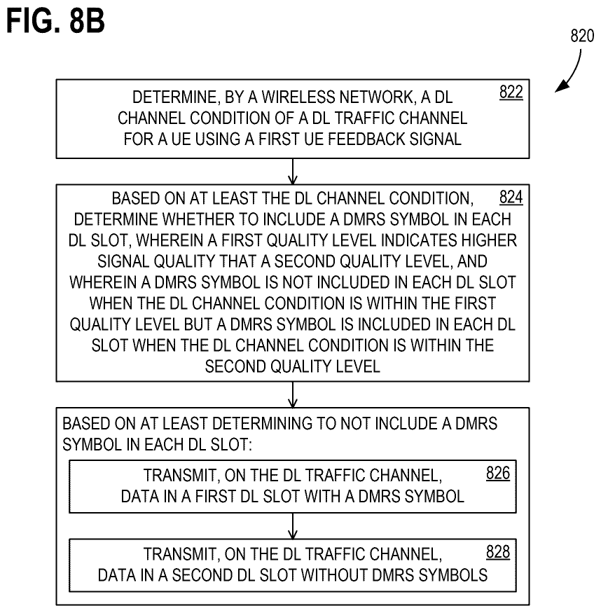

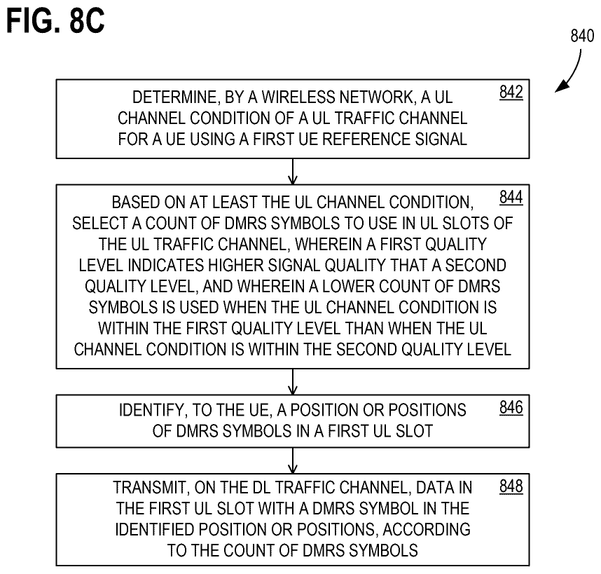

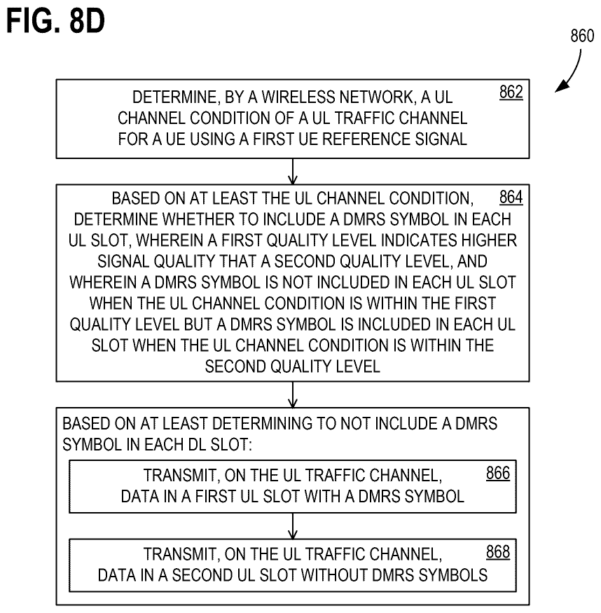

FIG. 8A illustrates a flowchart 800 of exemplary operations associated with architecture 100. In some examples, at least a portion of flowchart 800 may be performed using one or more computing devices 900 of FIG. 9. Flowchart 800 commences with operation 802, which includes determining, by a wireless network, a DL channel condition of a DL traffic channel for a UE using a first UE feedback signal.

Operation 804 includes, based on at least the DL channel condition, selecting a count of DMRS symbols to use in DL slots of the DL traffic channel, wherein a first quality level indicates higher signal quality that a second quality level, and wherein a lower count of DMRS symbols is used when the DL channel condition is within the first quality level than when the DL channel condition is within the second quality level. Operation 806 includes identifying, to the UE, a position or positions of DMRS symbols in a first DL slot. Operation 808 includes transmitting, on the DL traffic channel, data in the first DL slot with a DMRS symbol in the identified position or positions, according to the count of DMRS symbols.

FIG. 8B illustrates a flowchart 820 of exemplary operations associated with architecture 100. In some examples, at least a portion of flowchart 820 may be performed using one or more computing devices 900 of FIG. 9. Flowchart 820 commences with operation 822, which includes determining, by a wireless network, a DL channel condition of a DL traffic channel for a UE using a first UE feedback signal.

Operation 824 includes, based on at least the DL channel condition, determining whether to include a DMRS symbol in each DL slot, wherein a first quality level indicates higher signal quality that a second quality level, and wherein a DMRS symbol is not included in each DL slot when the DL channel condition is within the first quality level but a DMRS symbol is included in each DL slot when the DL channel condition is within the second quality level. Operations 826 and 828 are based on at least determining to not include a DMRS symbol in each DL slot. Operation 826 includes transmitting, on the DL traffic channel, data in a first DL slot with a DMRS symbol. Operation 828 includes transmitting, on the DL traffic channel, data in a second DL slot without DMRS symbols.

FIG. 8C illustrates a flowchart 840 of exemplary operations associated with architecture 100. In some examples, at least a portion of flowchart 840 may be performed using one or more computing devices 900 of FIG. 9. Flowchart 840 commences with operation 842, which includes determining, by a wireless network, a UL channel condition of a UL traffic channel for a UE using a first UE reference signal.

Operation 844 includes, based on at least the UL channel condition, selecting a count of DMRS symbols to use in UL slots of the UL traffic channel, wherein a first quality level indicates higher signal quality that a second quality level, and wherein a lower count of DMRS symbols is used when the UL channel condition is within the first quality level than when the UL channel condition is within the second quality level. Operation 846 includes identifying, to the UE, a position or positions of DMRS symbols in a first UL slot. Operation 848 includes transmitting, on the UL traffic channel, data in the first UL slot with a DMRS symbol in the identified position or positions, according to the count of DMRS symbols.

FIG. 8D illustrates a flowchart 860 of exemplary operations associated with architecture 100. In some examples, at least a portion of flowchart 860 may be performed using one or more computing devices 900 of FIG. 9. Flowchart 860 commences with operation 862, which includes determining, by a wireless network, a UL channel condition of a UL traffic channel for a UE using a first UE reference signal.

Operation 864 includes, based on at least the UL channel condition, determining whether to include a DMRS symbol in each UL slot, wherein a first quality level indicates higher signal quality that a second quality level, and wherein a DMRS symbol is not included in each UL slot when the UL channel condition is within the first quality level but a DMRS symbol is included in each UL slot when the UL channel condition is within the second quality level. Operations 866 and 868 are based on at least determining to not include a DMRS symbol in each UL slot. Operation 866 includes transmitting, on the UL traffic channel, data in a first UL slot with a DMRS symbol. Operation 868 includes transmitting, on the UL traffic channel, data in a second UL slot without DMRS symbols.

FIG. 9 illustrates a block diagram of computing device 900 that may be used as any component described herein that may require computational or storage capacity (e.g., a computer storage device). Computing device 900 has at least a processor 902 and a memory 904 that holds program code 910, data area 920, and other logic and storage 930. Memory 904 is any device allowing information, such as computer executable instructions and/or other data, to be stored and retrieved. For example, memory 904 may include one or more random access memory (RAM) modules, flash memory modules, hard disks, solid-state disks, persistent memory devices, and/or optical disks. Program code 910 comprises computer executable instructions and computer executable components including instructions used to perform operations described herein. Data area 920 holds data used to perform operations described herein. Memory 904 also includes other logic and storage 930 that performs or facilitates other functions disclosed herein or otherwise required of computing device 900. An input/output (I/O) component 940 facilitates receiving input from users and other devices and generating displays for users and outputs for other devices. A network interface 950 permits communication over external computer network 960 (e.g., computer network 124) with a remote node 970, which may represent another implementation of computing device 900. For example, a remote node 970 may represent another of the above-noted nodes within architecture 100.

### ADDITIONAL EXAMPLES

An example system comprises: a processor; and a computer-readable medium storing instructions that are operative upon execution by the processor to: determine, by a wireless network, a DL channel condition of a DL traffic channel for a UE using a first UE feedback signal; based on at least the DL channel condition, select a count of DMRS symbols to use in DL slots of the DL traffic channel, wherein a first quality level indicates higher signal quality that a second quality level, and wherein a lower count of DMRS symbols is used when the DL channel condition is within the first quality level than when the DL channel condition is within the second quality level; identify, to the UE, a position or positions of DMRS symbols in a first DL slot; and transmit, on the DL traffic channel, data in the first DL slot with a DMRS symbol in the identified position or positions, according to the count of DMRS symbols.

Another example system comprises: a processor; and a computer-readable medium storing instructions that are operative upon execution by the processor to: determine, by a wireless network, a DL channel condition of a DL traffic channel for a UE using a first UE feedback signal; based on at least the DL channel condition, determine whether to include a DMRS symbol in each DL slot, wherein a first quality level indicates higher signal quality that a second quality level, and wherein a DMRS symbol is not included in each DL slot when the DL channel condition is within the first quality level but a DMRS symbol is included in each DL slot when the DL channel condition is within the second quality level; and based on at least determining to not include a DMRS symbol in each DL slot: transmit, on the DL traffic channel, data in a first DL slot with a DMRS symbol; and transmit, on the DL traffic channel, data in a second DL slot without DMRS symbols.

Another example system comprises: a processor; and a computer-readable medium storing instructions that are operative upon execution by the processor to: determine, by a wireless network, a UL channel condition of a UL traffic channel for a UE using a first UE reference signal; based on at least the UL channel condition, select a count of DMRS symbols to use in UL slots of the UL traffic channel, wherein a first quality level indicates higher signal quality that a second quality level, and wherein a lower count of DMRS symbols is used when the UL channel condition is within the first quality level than when the UL channel condition is within the second quality level; identify, to the UE, a position or positions of DMRS symbols in a first UL slot; and transmit, on the UL traffic channel, data in the first UL slot with a DMRS symbol in the identified position or positions, according to the count of DMRS symbols.

Another example system comprises: a processor; and a computer-readable medium storing instructions that are operative upon execution by the processor to: determine, by a wireless network, a UL channel condition of a UL traffic channel for a UE using a first UE reference signal; based on at least the UL channel condition, determine whether to include a DMRS symbol in each UL slot, wherein a first quality level indicates higher signal quality that a second quality level, and wherein a DMRS symbol is not included in each UL slot when the UL channel condition is within the first quality level but a DMRS symbol is included in each UL slot when the UL channel condition is within the second quality level; and based on at least determining to not include a DMRS symbol in each UL slot: transmit, on the UL traffic channel, data in a first UL slot with a DMRS symbol; and transmit, on the UL traffic channel, data in a second UL slot without DMRS symbols.

An example method of wireless communication comprises: determining, by a wireless network, a DL channel condition of a DL traffic channel for a UE using a first UE feedback signal; based on at least the DL channel condition, selecting a count of DMRS symbols to use in DL slots of the DL traffic channel, wherein a first quality level indicates higher signal quality that a second quality level, and wherein a lower count of DMRS symbols is used when the DL channel condition is within the first quality level than when the DL channel condition is within the second quality level; identifying, to the UE, a position or positions of DMRS symbols in a first DL slot; and transmitting, on the DL traffic channel, data in the first DL slot with a DMRS symbol in the identified position or positions, according to the count of DMRS symbols.

Another example method of wireless communication comprises: determining, by a wireless network, a DL channel condition of a DL traffic channel for a UE using a first UE feedback signal; based on at least the DL channel condition, determining whether to include a DMRS symbol in each DL slot, wherein a first quality level indicates higher signal quality that a second quality level, and wherein a DMRS symbol is not included in each DL slot when the DL channel condition is within the first quality level but a DMRS symbol is included in each DL slot when the DL channel condition is within the second quality level; and based on at least determining to not include a DMRS symbol in each DL slot: transmitting, on the DL traffic channel, data in a first DL slot with a DMRS symbol; and transmitting, on the DL traffic channel, data in a second DL slot without DMRS symbols.

Another example method of wireless communication comprises: determining, by a wireless network, a UL channel condition of a UL traffic channel for a UE using a first UE reference signal; based on at least the UL channel condition, selecting a count of DMRS symbols to use in UL slots of the UL traffic channel, wherein a first quality level indicates higher signal quality that a second quality level, and wherein a lower count of DMRS symbols is used when the UL channel condition is within the first quality level than when the UL channel condition is within the second quality level; identifying, to the UE, a position or positions of DMRS symbols in a first UL slot; and transmitting, on the UL traffic channel, data in the first UL slot with a DMRS symbol in the identified position or positions, according to the count of DMRS symbols.

Another example method of wireless communication comprises: determining, by a wireless network, a UL channel condition of a UL traffic channel for a UE using a first UE reference signal; based on at least the UL channel condition, determining whether to include a DMRS symbol in each UL slot, wherein a first quality level indicates higher signal quality that a second quality level, and wherein a DMRS symbol is not included in each UL slot when the UL channel condition is within the first quality level but a DMRS symbol is included in each UL slot when the UL channel condition is within the second quality level; and based on at least determining to not include a DMRS symbol in each UL slot: transmitting, on the UL traffic channel, data in a first UL slot with a DMRS symbol; and transmitting, on the UL traffic channel, data in a second UL slot without DMRS symbols.

One or more example computer storage devices has computer-executable instructions stored thereon, which, upon execution by a computer, cause the computer to perform operations comprising: determining, by a wireless network, a DL channel condition of a DL traffic channel for a UE using a first UE feedback signal; based on at least the DL channel condition, selecting a count of DMRS symbols to use in DL slots of the DL traffic channel, wherein a first quality level indicates higher signal quality that a second quality level, and wherein a lower count of DMRS symbols is used when the DL channel condition is within the first quality level than when the DL channel condition is within the second quality level; identifying, to the UE, a position or positions of DMRS symbols in a first DL slot; and transmitting, on the DL traffic channel, data in the first DL slot with a DMRS symbol in the identified position or positions, according to the count of DMRS symbols.

One or more example computer storage devices has computer-executable instructions stored thereon, which, upon execution by a computer, cause the computer to perform operations comprising: determining, by a wireless network, a DL channel condition of a DL traffic channel for a UE using a first UE feedback signal; based on at least the DL channel condition, determining whether to include a DMRS symbol in each DL slot, wherein a first quality level indicates higher signal quality that a second quality level, and wherein a DMRS symbol is not included in each DL slot when the DL channel condition is within the first quality level but a DMRS symbol is included in each DL slot when the DL channel condition is within the second quality level; and based on at least determining to not include a DMRS symbol in each DL slot: transmitting, on the DL traffic channel, data in a first DL slot with a DMRS symbol; and transmitting, on the DL traffic channel, data in a second DL slot without DMRS symbols.

One or more example computer storage devices has computer-executable instructions stored thereon, which, upon execution by a computer, cause the computer to perform operations comprising: determining, by a wireless network, a UL channel condition of a UL traffic channel for a UE using a first UE reference signal; based on at least the UL channel condition, selecting a count of DMRS symbols to use in UL slots of the UL traffic channel, wherein a first quality level indicates higher signal quality that a second quality level, and wherein a lower count of DMRS symbols is used when the UL channel condition is within the first quality level than when the UL channel condition is within the second quality level; identifying, to the UE, a position or positions of DMRS symbols in a first UL slot; and transmitting, on the UL traffic channel, data in the first UL slot with a DMRS symbol in the identified position or positions, according to the count of DMRS symbols.

One or more example computer storage devices has computer-executable instructions stored thereon, which, upon execution by a computer, cause the computer to perform operations comprising: determining, by a wireless network, a UL channel condition of a UL traffic channel for a UE using a first UE reference signal; based on at least the UL channel condition, determining whether to include a DMRS symbol in each UL slot, wherein a first quality level indicates higher signal quality that a second quality level, and wherein a DMRS symbol is not included in each UL slot when the UL channel condition is within the first quality level but a DMRS symbol is included in each UL slot when the UL channel condition is within the second quality level; and based on at least determining to not include a DMRS symbol in each UL slot: transmitting, on the UL traffic channel, data in a first UL slot with a DMRS symbol; and transmitting, on the UL traffic channel, data in a second UL slot without DMRS symbols.

Alternatively, or in addition to the other examples described herein, examples include any combination of the following:
the wireless network comprises a cellular network;
the UE comprises an eMBB, a cellphone, an FWA, a CPE, an IoT device, an M2M communication device, or a PC with a cellular modem;
the DMRS symbols are 5G DMRS symbols;
the count of DMRS symbols is one for the first quality level;
the count of DMRS symbols is two for the second quality level;
when the count is one, the position is 7, or 2, or 11;
when the count is two, the positions are 2 and 11;
based on at least the DL channel condition, determining whether to include a DMRS symbol in each DL slot;
a DMRS symbol is not included in each DL slot when the DL channel condition is within the first quality level but a DMRS symbol is included in each DL slot when the DL channel condition is within the second quality level;
based on at least determining to not include a DMRS symbol in each DL slot, transmitting, on the DL traffic channel, data in a second DL slot without DMRS symbols;
based on at least determining to not include a DMRS symbol in each DL slot, determining how many subsequent DL slots in which to not include a DMRS symbol, such that DMRS symbols are transmitted only every N DL slots;
N is greater than 1;
based on at least determining that the DL channel condition is within the first quality level, multiplexing the DL traffic channel and/or not using a power boost for the DMRS symbols;
based on at least determining that the DL channel condition is within the second quality level, using a power boost for the DMRS symbols and/or not multiplexing the DL traffic channel;
determining the DL channel condition of the DL channel uses a plurality of UE feedback signals that includes the first UE feedback signal;
each UE feedback signal of the plurality of UE feedback signals comprises CSI or an MR;
the DL channel condition is within the first quality level when the DL channel condition exceeds a first signal quality threshold for a plurality of UE feedback signals that includes the first UE feedback signal;
an AI model determines the DL channel condition or selects the count of DMRS symbols using the plurality of UE feedback signals;
the DL traffic channel comprises a PDSCH;
based on at least the DL channel condition, selecting a count of DMRS symbols to use in DL slots of the DL traffic channel;
a lower count of DMRS symbols is used when the DL channel condition is within the first quality level than when the DL channel condition is within the second quality level;
identifying, to the UE, a position or positions of DMRS symbols in a first DL slot;
transmitting data in the first DL slot comprises transmitting the data with a DMRS symbol in the identified position or positions, according to the count of DMRS symbols;
an AI model determines the DL channel condition or determines whether to include a DMRS symbol in each DL slot;
based on at least the UL channel condition, determining whether to include a DMRS symbol in each UL slot;
a DMRS symbol is not included in each UL slot when the UL channel condition is within the first quality level but a DMRS symbol is included in each UL slot when the UL channel condition is within the second quality level;
based on at least determining to not include a DMRS symbol in each UL slot, transmitting, on the UL traffic channel, data in a second UL slot without DMRS symbols;
based on at least determining to not include a DMRS symbol in each UL slot, determining how many subsequent UL slots in which to not include a DMRS symbol, such that DMRS symbols are transmitted only every N UL slots;
based on at least determining that the UL channel condition is within the first quality level, multiplexing the UL traffic channel and/or not using a power boost for the DMRS symbols;
based on at least determining that the UL channel condition is within the second quality level, using a power boost for the DMRS symbols and/or not multiplexing the UL traffic channel;
determining the UL channel condition of the UL channel uses a plurality of UE reference signals that includes the first UE reference signal;
each UE reference signal of the plurality of UE reference signals comprises a DMRS symbol on the UL traffic channel or an SRS;
the UL channel condition is within the first quality level when the UL channel condition exceeds a first signal quality threshold for a plurality of UE reference signals that includes the first UE reference signal;
an AI model determines the UL channel condition or selects the count of DMRS symbols using the plurality of UE reference signals;
the UL traffic channel comprises a PUSCH;
based on at least the UL channel condition, selecting a count of DMRS symbols to use in UL slots of the UL traffic channel
a lower count of DMRS symbols is used when the UL channel condition is within the first quality level than when the UL channel condition is within the second quality level;
identifying, to the UE, a position or positions of DMRS symbols in a first UL slot
transmitting data in the first UL slot comprises transmitting the data with a DMRS symbol in the identified position or positions, according to the count of DMRS symbols;
an AI model determines the UL channel condition or determines whether to include a DMRS symbol in each UL slot;
receiving the plurality of UE feedback signals;
receiving the plurality of UE reference signals;
determining the DL channel condition comprises estimating the DL channel condition;
determining the UL channel condition comprises estimating the UL channel condition;
a base station of the wireless network performs the DL channel condition and/or the UL channel condition determinations;
the base station comprises a gNB or an eNB;
the CSI comprises a HARQ ACK signal, a HARQ NACK signal, a CQI, or a PMI;
the MR comprises RSRP, RSRQ, or SINR;
the count of DMRS symbols is for a single frequency in a DL slot or a UL slot;
the DL channel condition is within a third quality level when the DL channel condition exceeds a second signal quality threshold;
the third quality level indicates higher signal quality that the first quality level;
a DMRS symbol is not included in each DL slot when the DL channel condition is within the third quality level;
a DMRS symbol is included in each DL slot when the DL channel condition is within the first quality level but not within the third quality level;
the UL channel condition is within a third quality level when the UL channel condition exceeds a second signal quality threshold;
the third quality level indicates higher signal quality that the first quality level;
a DMRS symbol is not included in each UL slot when the DL channel condition is within the third quality level; and
a DMRS symbol is included in each UL slot when the UL channel condition is within the first quality level but not within the third quality level.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure. It will be understood that the benefits and advantages described above may relate to one embodiment or may relate to several embodiments. When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.”

Having described aspects of the disclosure in detail, it will be apparent that modifications and variations are possible without departing from the scope of aspects of the disclosure as defined in the appended claims. As various changes may be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A method comprising:
determining, by a wireless network, a downlink (DL) channel condition of a DL traffic channel for a user equipment (UE) using a first UE feedback signal;
based on at least the DL channel condition, selecting a count of demodulation reference signal (DMRS) symbols to use in DL slots of the DL traffic channel, wherein a first quality level indicates higher signal quality that a second quality level, and wherein a lower count of DMRS symbols is used when the DL channel condition is within the first quality level than when the DL channel condition is within the second quality level;
identifying, to the UE, a position or positions of DMRS symbols in a first DL slot; and
transmitting, on the DL traffic channel, data in the first DL slot with a DMRS symbol in the identified position or positions, according to the count of DMRS symbols.

2. The method of claim 1, wherein the count of DMRS symbols is one for the first quality level, and wherein the count of DMRS symbols is two for the second quality level.

3. The method of claim 1,
wherein, when the count is one, the position is 7, or 2, or 11; and/or
wherein, when the count is two, the positions are 2 and 11.

4. The method of claim 1, further comprising:
based on at least the DL channel condition, determining whether to include a DMRS symbol in each DL slot, wherein a DMRS symbol is not included in each DL slot when the DL channel condition is within the first quality level but a DMRS symbol is included in each DL slot when the DL channel condition is within the second quality level; and
based on at least determining to not include a DMRS symbol in each DL slot, transmitting, on the DL traffic channel, data in a second DL slot without DMRS symbols.

5. The method of claim 4, further comprising:
based on at least determining to not include a DMRS symbol in each DL slot, determining how many subsequent DL slots in which to not include a DMRS symbol, such that DMRS symbols are transmitted only every N DL slots, wherein N is greater than 1.

6. The method of claim 1, further comprising:
based on at least determining that the DL channel condition is within the first quality level, multiplexing the DL traffic channel and/or not using a power boost for the DMRS symbols; or
based on at least determining that the DL channel condition is within the second quality level, using a power boost for the DMRS symbols and/or not multiplexing the DL traffic channel.

7. The method of claim 1,
wherein determining the DL channel condition of the DL channel uses a plurality of UE feedback signals that includes the first UE feedback signal;
wherein each UE feedback signal of the plurality of UE feedback signals comprises channel state information (CSI) or a measurement report (MR); and
wherein either:
the DL channel condition is within the first quality level when the DL channel condition exceeds a first signal quality threshold for a plurality of UE feedback signals that includes the first UE feedback signal; or
an artificial intelligence (AI) model determines the DL channel condition or selects the count of DMRS symbols using the plurality of UE feedback signals.

8. The method of claim 1, wherein the DL traffic channel comprises a physical downlink shared channel (PDSCH).

9. A system comprising:
a processor; and
a computer-readable medium storing instructions that are operative upon execution by the processor to:
determine, by a wireless network, a downlink (DL) channel condition of a DL traffic channel for a user equipment (UE) using a first UE feedback signal;
based on at least the DL channel condition, select a count of demodulation reference signal (DMRS) symbols to use in DL slots of the DL traffic channel, wherein a first quality level indicates higher signal quality that a second quality level, and wherein a lower count of DMRS symbols is used when the DL channel condition is within the first quality level than when the DL channel condition is within the second quality level;
identify, to the UE, a position or positions of DMRS symbols in a first DL slot; and
transmit, on the DL traffic channel, data in the first DL slot with a DMRS symbol in the identified position or positions, according to the count of DMRS symbols.

10. The system of claim 9, wherein the count of DMRS symbols is one for the first quality level, and wherein the count of DMRS symbols is two for the second quality level.

11. The system of claim 9,
wherein, when the count is one, the position is 7, or 2, or 11; and/or
wherein, when the count is two, the positions are 2 and 11.

12. The system of claim 9, wherein the operations are further operative to:
based on at least the DL channel condition, determine whether to include a DMRS symbol in each DL slot, wherein a DMRS symbol is not included in each DL slot when the DL channel condition is within the first quality level but a DMRS symbol is included in each DL slot when the DL channel condition is within the second quality level; and
based on at least determining to not include a DMRS symbol in each DL slot, transmit, on the DL traffic channel, data in a second DL slot without DMRS symbols.

13. The system of claim 12, wherein the operations are further operative to:
based on at least determining to not include a DMRS symbol in each DL slot, determine how many subsequent DL slots in which to not include a DMRS symbol, such that DMRS symbols are transmitted only every N DL slots, wherein N is greater than 1.

14. The system of claim 9,
wherein determining the DL channel condition of the DL channel uses a plurality of UE feedback signals that includes the first UE feedback signal;
wherein each UE feedback signal of the plurality of UE feedback signals comprises channel state information (CSI) or a measurement report (MR); and
wherein either:
the DL channel condition is within the first quality level when the DL channel condition exceeds a first signal quality threshold for a plurality of UE feedback signals that includes the first UE feedback signal; or
an artificial intelligence (AI) model determines the DL channel condition or selects the count of DMRS symbols using the plurality of UE feedback signals.

15. One or more computer storage devices having computer-executable instructions stored thereon, which, upon execution by a computer, cause the computer to perform operations comprising:
determining, by a wireless network, a downlink (DL) channel condition of a DL traffic channel for a user equipment (UE) using a first UE feedback signal;
based on at least the DL channel condition, selecting a count of demodulation reference signal (DMRS) symbols to use in DL slots of the DL traffic channel, wherein a first quality level indicates higher signal quality that a second quality level, and wherein a lower count of DMRS symbols is used when the DL channel condition is within the first quality level than when the DL channel condition is within the second quality level;
identifying, to the UE, a position or positions of DMRS symbols in a first DL slot; and
transmitting, on the DL traffic channel, data in the first DL slot with a DMRS symbol in the identified position or positions, according to the count of DMRS symbols.

16. The one or more computer storage devices of claim 15, wherein the count of DMRS symbols is one for the first quality level, and wherein the count of DMRS symbols is two for the second quality level.

17. The one or more computer storage devices of claim 15,
wherein, when the count is one, the position is 7, or 2, or 11; and/or
wherein, when the count is two, the positions are 2 and 11.

18. The one or more computer storage devices of claim 15, wherein the operations further comprise:
based on at least the DL channel condition, determining whether to include a DMRS symbol in each DL slot, wherein a DMRS symbol is not included in each DL slot when the DL channel condition is within the first quality level but a DMRS symbol is included in each DL slot when the DL channel condition is within the second quality level; and
based on at least determining to not include a DMRS symbol in each DL slot, transmitting, on the DL traffic channel, data in a second DL slot without DMRS symbols.

19. The one or more computer storage devices of claim 18, wherein the operations further comprise:
based on at least determining to not include a DMRS symbol in each DL slot, determining how many subsequent DL slots in which to not include a DMRS symbol, such that DMRS symbols are transmitted only every N DL slots, wherein N is greater than 1.

20. The one or more computer storage devices of claim 15,
wherein determining the DL channel condition of the DL channel uses a plurality of UE feedback signals that includes the first UE feedback signal;
wherein each UE feedback signal of the plurality of UE feedback signals comprises channel state information (CSI) or a measurement report (MR); and
wherein either:
the DL channel condition is within the first quality level when the DL channel condition exceeds a first signal quality threshold for a plurality of UE feedback signals that includes the first UE feedback signal; or
an artificial intelligence (AI) model determines the DL channel condition or selects the count of DMRS symbols using the plurality of UE feedback signals.
